(19) United States
(12) Patent Application Publication
(10) Pub. No.: US 2009/0140109 A1
(43) Pub. Date: Jun. 4, 2009

(54) Face up - face down - rotating laptop computer stand and holder

(76) Inventor: Alan Michael Watson, Birmingham, AL (US)

Correspondence Address: Alan Michael Watson, 2022 Montreat Parkway, Birmingham, AL, 35216, US

(21) Appl. No.: 12/287,938

(22) Filed: Oct. 15, 2008

Related U.S. Application Data
(60) Provisional application No. 60/998,896, filed on Oct. 15, 2007.

(51) Int. Cl. F16M 11/20

(52) U.S. Cl. 248/176.1

(57) ABSTRACT

These are laptop computer stands designed to secure a laptop computer inverted up to 90 degrees over the head of the user so that the computer can be operated by the user in a prone head back position if so desired. These stands have fasteners to secure the laptop computer to a frame that connects to a stand with a base. These stands have connections between the frame and stand allowing the laptop computer to rotate up to 360 degrees and/or tilt 360 degrees around its axis. There is a lever to lock the laptop computer in any position.

### BRIEF DESCRIPTION OF THE DRAWINGS

FIG. 1 is a frontal view of the described adaptable laptop computer stand with a flat base.

FIG. 2 is a perspective view of the laptop computer stand with a mobile floor base.

FIG. 3 is a perspective view of the laptop computer stand showing the frame with clamps holding the computer in an inverted position.

FIG. 4 is a side view of the described computer stand and frame holding the computer over and above a pillow and bed. The rotating ball connection can be seen attached to the frame holding the computer.

### DESCRIPTION OF THE PREFERRED EMBODIMENTS

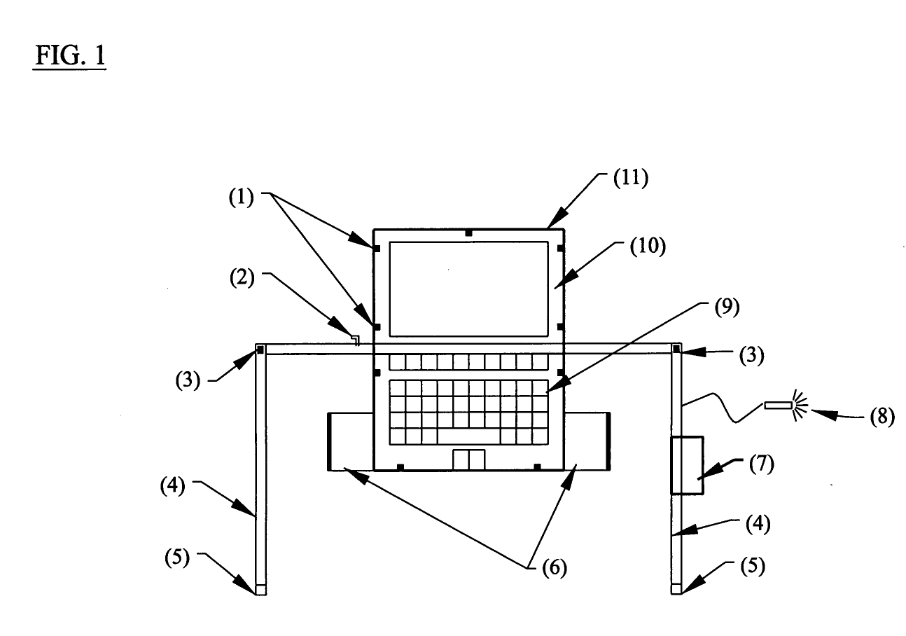

Referring to the accompanying FIGS. 1-4, there is shown and described a computer stand (see FIG. 1) with a flat base 5 designed to rest on both sides of its user holding and positioning a laptop computer 10 over the head and chest of its operator so the computer 10 can be inverted with the screen and keyboard 9 facing down and operated from below with the user lying between the vertical supports 4. The vertical supports 4 are approximately 20 inches in height with locking nuts 3 at the upper end of each support. The vertical supports 4 are of a hollow tube design made of steel or aluminum approximately one inch in diameter. A tube in a tube design allows the user to loosen the locking nuts 3 on each side for height adjustment. Connecting the vertical supports 4 is a horizontal cross bar. Attached at the center of the horizontal cross bar is a wire frame 11 made of steel which is in the shape of an opened laptop computer.

The wire frame has approximately nine clamps 1 spaced at points around its perimeter. These clamps 1 are adjustable so that a laptop computer 10 can be placed against the wire frame 11 and between the adjustable clamps 1 and securely held in place. The wire frame 11 has hinges at its back and center which allow the laptop computer 10 to be opened and closed while attached to the wire frame.

There is a lever 2 on the cross bar. This lever 2 allows the cross bar to work as an axis in which the frame 11 holding the laptop 10 can be rotated 360 degrees around the axis and locked into place at any angle.

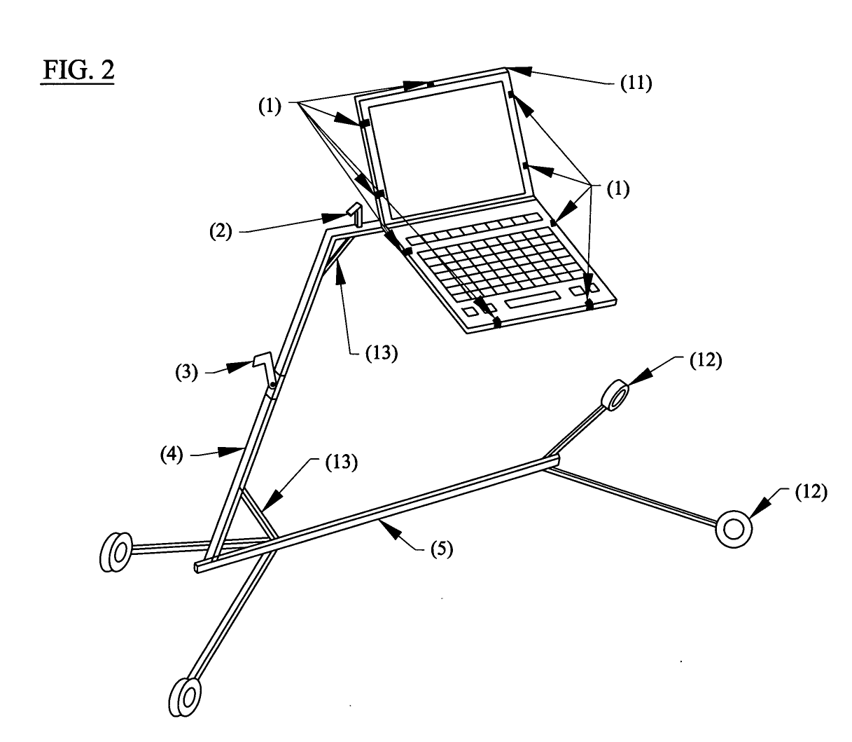

FIG. 2 shows a computer stand with a base that has wheels 5. This stand is designed to rest on the floor. This stand has one vertical support 4 with a horizontal bar at its upper end. The vertical bar 4 has supports 13 at either end for added strength. There is a locking lever 3 on the vertical arm 4 for height adjustment. The horizontal bar at the upper end of the vertical support bar 4 supports a wire frame 11 with clamps 1 as described for FIG. 1. There is a lever for rotation 2 as described for FIG. 1. This stand is designed so that the laptop computer 10 can be supported from the floor holding the laptop computer 10 suspended over its user in a bed 15.

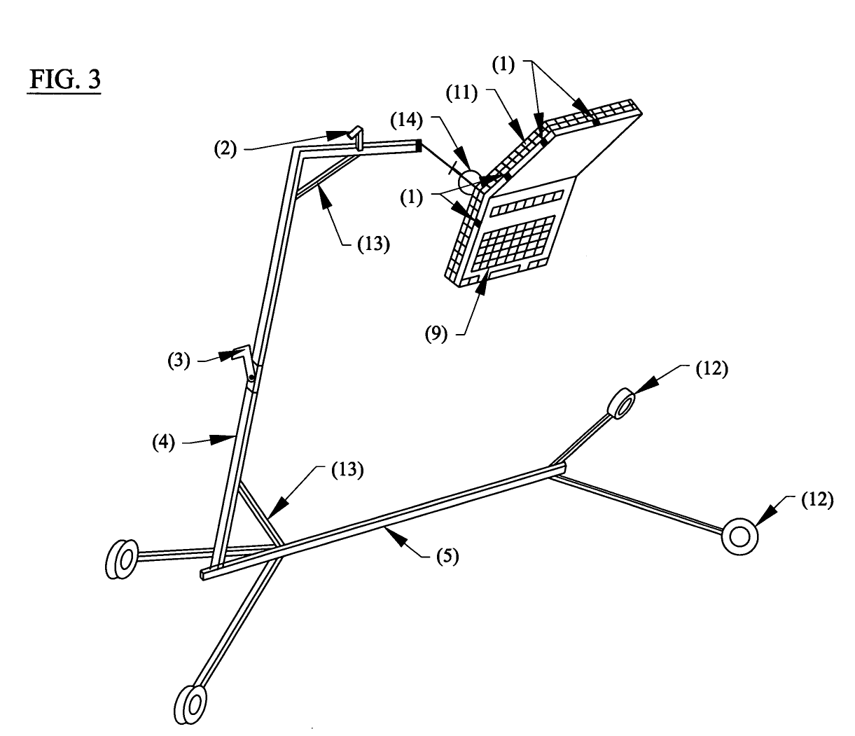

FIG. 3 is a perspective of a laptop computer stand as described in FIG. 2. This stand, however, is also equipped with a rotating ball connection 14 between the laptop computer holding frame 11 and the horizontal bar 14 which enables the laptop computer 10 to be rotated onto its side and to be held in a secure position. in alignment with a user who is lying on his or her side.

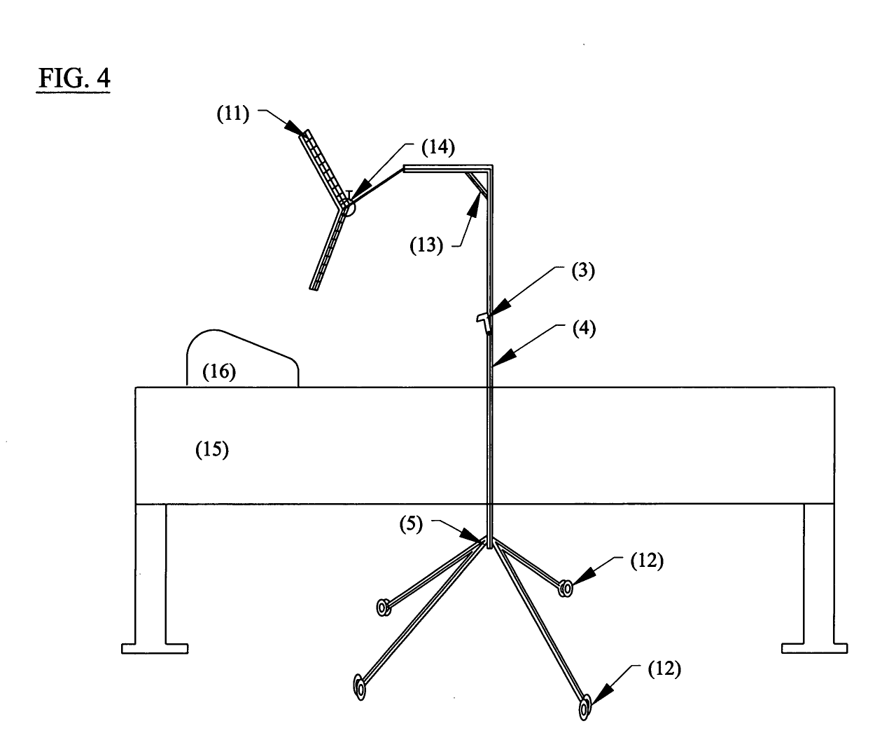

FIG. 4 is a perspective of a laptop computer stand with a rotating ball connection 14 as described in FIG. 3. The laptop computer stand is shown holding the laptop computer frame 11 suspended above a pillow 16 and bed 15. On the rotating ball connection 14 there is a locking lever which allows the user to lock the computer in an inverted and rotated position if desired.

In compliance with the statute, the invention has been described in language more or less specific as to structural features. It should be understood, however, that the invention is not limited to the specific features shown, since the means and construction shown comprise only some of the preferred embodiments for putting the invention into effect. The invention is therefore entitled to any of its forms or modifications within the legitimate and valid scope of the amended claims, appropriately interpreted in accordance with the doctrine of equivalents.

I claim:

1. A frame and a stand that securely hold a laptop computer in any position comprising:
a. A frame with clamps.
b. A rotating ball connection that connects the frame to the stand.
c. A connection between the frame and stand that allows the frame to rotate around its axis 360 degrees.
d. A ball joint that allows the frame to rotate 360 degrees.
e. A lever to lock the connections in any position.
f. A frame with latches to hold a notebook or book.
g. A wire frame and a stand to hold a laptop computer so that it can be operated in an inverted position from below.
h. A frame and stand designed to hold a laptop computer over the head and chest of its operator while lying down.
i. A custom frame designed to properly fit a laptop computer and support it securely with fasteners.
